(19) United States
(12) Patent Application Publication
(10) Pub. No.: US 2002/0088329 A1
(43) Pub. Date: Jul. 11, 2002

(54) Band saw blade stabilizer

(76) Inventor: Torben Helshoj, Laguna Beach, CA (US)

Correspondence Address: STETINA BRUNDA GARRED & BRUCKER, 75 ENTERPRISE, SUITE 250, ALISO VIEJO, CA, 92656, US

(21) Appl. No.: 09/755,222

(22) Filed: Jan. 5, 2001

(51) Int. Cl. B27B 13/10

(52) U.S. Cl. 83/820; 83/829

(57) ABSTRACT

A band saw blade stabilizer for stabilizing a moving band saw blade of a band saw appliance. The blade stabilizer includes two opposing guide structures situated to form a passage there between within which the saw blade travels while the guide structures limit lateral motion thereof. An attachment mount is included for securing the guide structures above a standard work table. Preferably, at least one of the guide structures is provided with an adjustor for selective lateral movement thereof for selective change of passage width. The stabilizer can additionally include a thrust bearing situated behind the blade for limiting rearward movement thereof as can occur when a workpiece is cut. In this manner, traditional band saw appliance utility is maintained while precision-cutting versatility is enhanced as lateral and longitudinal blade movement is controlled with precision.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates in general to blade movement control in automated cutting equipment, and in particular to a band saw blade stabilizer selectively positionable above an integral work table and situated to provide lateral movement limitation of a moving band saw blade by maintaining a restrictive passage within which the blade must travel, thereby significantly reducing or substantially eliminating blade flutter during band saw operation.

Band saw appliances are commonly present and commonly used pieces of equipment in the construction of numerous products built of wood. Such products include furniture, cabinetry, flooring, framing, and other structures of both large and small scales. A band saw appliance includes a continuous blade traveling vertically through a slot positioned in a work table such that a workpiece is advanced on the surface of the table into the moving blade to effectuate a cut through the workpiece. Because a relatively long length of saw blade is exposed at the cutting site, the blade tends to repeatedly move from side to side during operation. This movement results in blade flutter that can adversely affect both safety and work quality. In particular, with respect to the former, excessive blade oscillation can result in blade breakage and an accompanying projectile launch of the blade band into the area surrounding the appliance. With respect to work quality, such lateral vacillation can significantly interfere with straight-cut production and acceptable end products.

In Applicant's co-pending U.S. patent application Ser. No. 09/478,111, filed Jan. 4, 2000, entitled “Band Saw Blade Guide,” and incorporated herein by reference, a throat plate with underside, integral, opposing blade-guide structures between which a band saw blade travels is taught for placement in the work table. While this apparatus provides lower blade control, the guide structures thereof are beneath the work table and are stationary, thus not providing topside blade control or a distance choice with respect to the work table and workpiece.

In view of the above concerns for both safety and product quality, it apparent that effective saw blade stabilization would be highly beneficial in band saw appliance operation. Accordingly, a primary object of the present invention is to provide a band saw blade stabilizer for laterally stabilizing a band saw blade during operation.

Another object of the present invention is to provide a band saw blade stabilizer mountable above the work table of a band saw appliance and selectively spaceable from the work table.

Yet another object of the present invention is to provide a band saw blade stabilizer whose stabilizing configuration is adjustable with respect to cutting conditions of a workpiece.

These and other objects of the present invention will become apparent throughout the description thereof which now follows.

### BRIEF SUMMARY OF THE INVENTION

The present invention is a band saw blade stabilizer for stabilizing a moving band saw blade of a band saw appliance, and includes a band saw appliance having the saw blade stabilizer. The blade stabilizer includes two opposing guide structures situated to form a passage there between with a passage width such that the moving band saw blade can pass within the passage while the guide structures limit lateral motion of the moving saw blade within the passage. An attachment mount is included for securing the guide structures to the band saw appliance above a work table of the appliance and through which the band saw blade travels. Preferably, at least one of the guide structures is provided with an adjustor for selective lateral movement of the at least one guide structure toward and away from the opposing guide structure for selective change of passage width. The stabilizer can additionally include a thrust bearing situated behind the saw blade for limiting rearward movement of the blade as can occur as a workpiece is presented for cutting. Configuring the two opposing guide structures as cubes results in substantially flat opposing surfaces between which the band saw blade travels and is controlled with respect to oscillatory movements. In this manner, safety and work-product quality both are attainable as a band saw appliance approximates jig saw efficiency in precision blade stability.

### BRIEF DESCRIPTION OF THE DRAWINGS

An illustrative and presently preferred embodiment of the invention is shown in the accompanying drawings in which:

FIG. 1 is perspective view of a band saw appliance with a band saw blade stabilizer in place;

FIG. 2 is an exploded disassembled view of the blade stabilizer of FIG. 1;

FIG. 3 is a side elevation view along line 3-3 of FIG. 1, except with a workpiece therewith; and

FIG. 4 is a perspective view of the blade stabilizer in assembled configuration.

### DETAILED DESCRIPTION OF THE PREFERRED EMBODIMENT

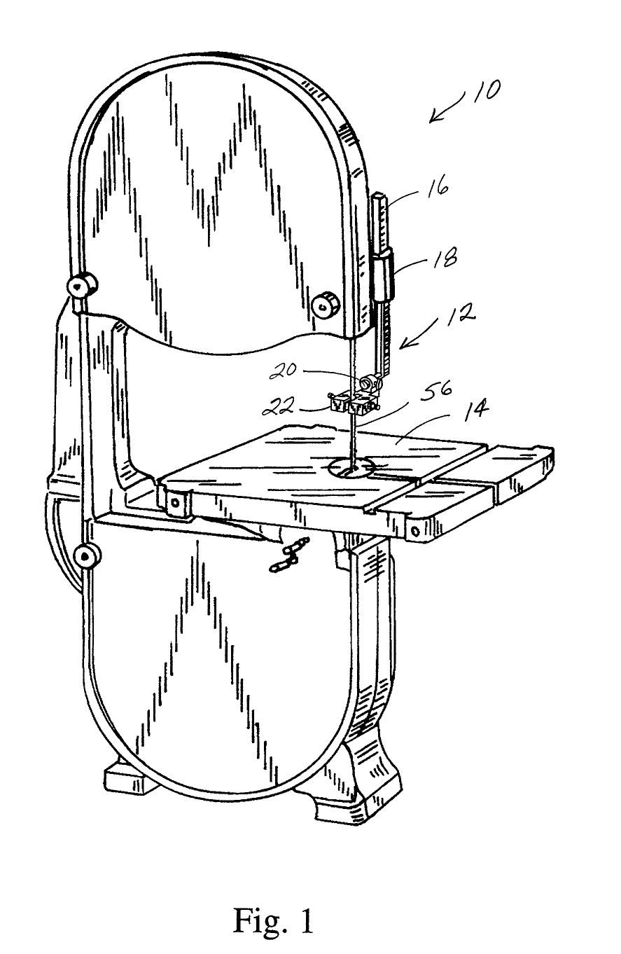

Referring first to FIG. 1, a band saw appliance 10 is shown with a band saw blade stabilizer 12 mounted above a conventional work table 14 of the band saw appliance 10. In particular, an attachment mount here configured as a shaft 16 is conventionally slidably mounted within a sleeve 18 affixed to the appliance 10 for selective distance positioning above the work table 14. A knob 20 projects inwardly at substantially 90° from the shaft 16 and retains a blade travel guide 22 as described below.

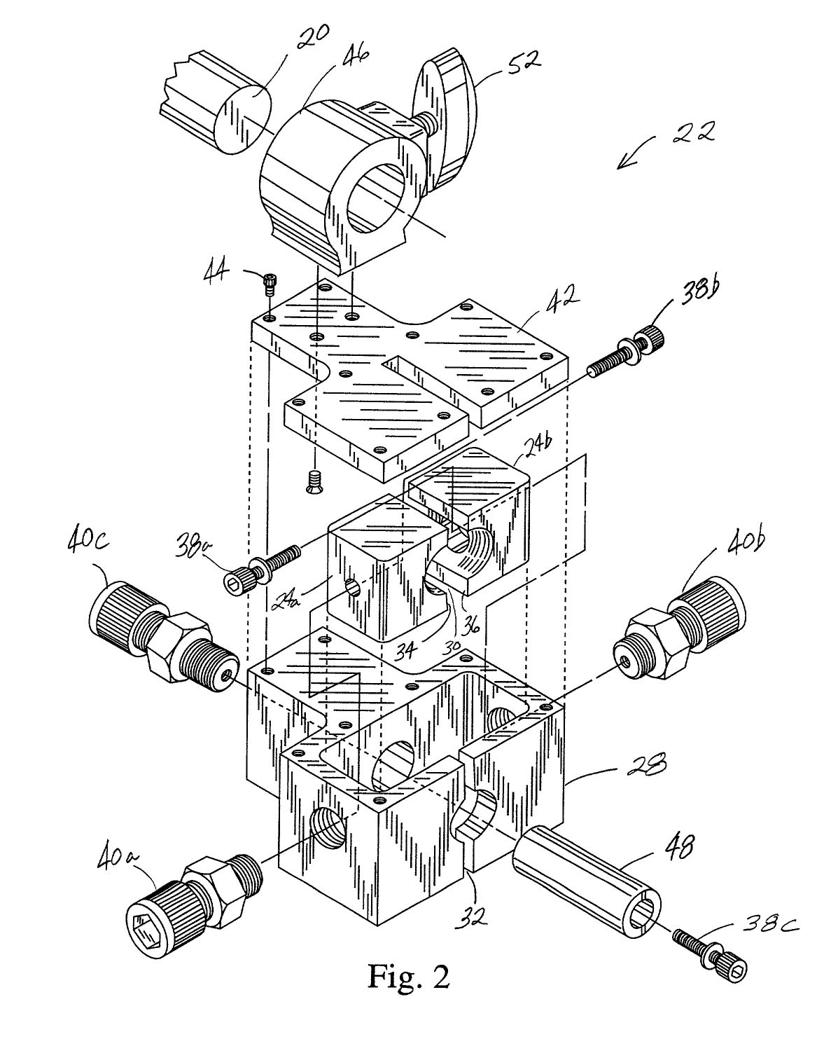

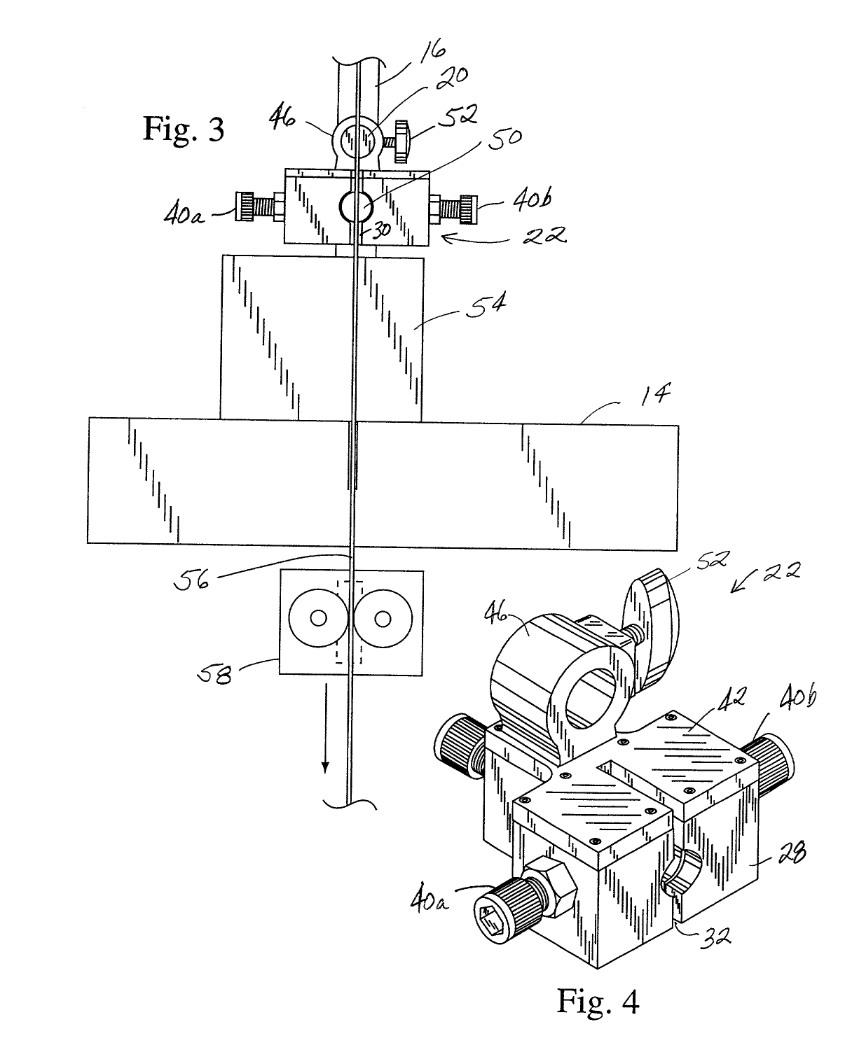

FIGS. 2 and 4 define the blade travel guide 22. In particular, the travel guide 22 has two opposing guide structures 24a, 24b each configured as a cube shape and disposed within a single housing 28 to present substantially flat opposing surfaces 34, 36 to each other. The guide structures 24a, 24b, preferably fabricated of ceramic, are spaced to form a passage 30 therebetween, while the housing 28 has a cut-out 32 in alignment with the passage 30. Assembly of the travel guide 22 is clearly shown in FIG. 2 where the guide structures 24a, 24b are first retained within the housing 28 with respective set screws 38a, 38b whose respective distal ends are situated within a respective guide structure 24a, 24b. The proximal ends of the set screws 38a, 38b are threadably accepted within respective externally projecting hand rotatable conventional set screw adjustors 40a, 40b, whereby adjustor rotation causes movement of the guide structures 24a, 24b toward or away from each other with accompanying decrease or increase of the width of the passage 30. Once the guide structures 24a, 24b are in place, the top 42 of the housing 28 is secured with conventional screws 44 subsequent to standard screw attachment of an upwardly projecting ring structure 46 onto the top 42. Finally, a sleeve 48 for accepting a thrust bearing 50 (FIG. 3) is placed within the rear of the housing 28 and a set screw 38c is advanced through the sleeve 48 for threaded engagement with a set screw adjustor 40c whereby adjustor rotation by hand causes forward and rearward movement of the sleeve 48. The ring structure 46 accepts the knob 20 as said knob projects inwardly from the shaft 16 of the attachment mount and is stationarily retained therein by rotation of the exteriorly-handled stop 52 conventionally extending through the wall of the ring structure 46 to abut and frictionally engage the knob 20.

Operation of the band saw appliance 10 is illustrated in FIG. 3. Specifically, a workpiece such as a piece of wood 54 is present on the work table 14 and shown immediately after being cut with the band saw blade 56. (A conventional lower blade guide 58 is situated below the table 14.) As illustrated, the travel guide 22 is positioned immediately above the piece of wood 54. With the blade 56 situated within the passage 30 and set screw adjustors 40a, 40b are rotated to create a passage 30 of minimal width without having the blade 56 in contact with the opposing blade guide structures 24a, 24b when the blade 56 is not moving. In like manner, the location of the thrust bearing 50 is adjusted via set screw adjustor 40c such that the blade 56 is nearly in contact with the thrust bearing 50 when the blade 56 is not moving. Thereafter, the appliance 10 is powered and the blade 56 moves vertically through the passage 30, but such movement is controlled by the travel guide 22. In particular, side-to-side flutter of the blade 56 is effectively limited by the opposing guide structures 24a, 24b as blade contact therewith automatically halts lateral movement. Simultaneously, front-to-back slack movement of the blade 56 is effectively limited by the thrust bearing 50 as rearward blade pressure by the workpiece is counteracted by the bearing 50 as the blade 56 comes in contact therewith and is prohibited from further longitudinal movement. In this manner, the present band saw blade stabilizer maintains traditional band saw appliance utility while enhancing precision-cutting versatility as the controlled moving blade confers lateral and longitudinal stability more common to highly sophisticated cutting equipment.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. A band saw blade stabilizer for stabilizing a moving band saw blade of a band saw appliance, the stabilizer comprising:
a) two opposing guide structures situated to form a passage there between with a passage width such that the moving band saw blade can pass within said passage, whereby said guide structures limit lateral motion of the moving band saw blade within said passage; and
b) an attachment mount for securing the guide structures to the band saw appliance above a work table of said appliance and through which the band saw blade travels.

2. A band saw blade stabilizer as claimed in claim 1 wherein the attachment mount is selectively vertically adjustable for increasing and decreasing distance of the guide structures from the work table.

3. A band saw blade stabilizer as claimed in claim 1 wherein the two guide structures are disposed within a single housing having a cut-out therethrough in alignment with the passage.

4. A band saw blade stabilizer as claimed in claim 1 wherein the guide structures are configured to present substantially flat opposing surfaces to each other.

5. A band saw blade stabilizer as claimed in claim 4 wherein the guide structures are configured as cubes.

6. A band saw blade stabilizer as claimed in claim 1 wherein at least one of said guide structures is provided with an adjustor for selective lateral movement of said at least one guide structure toward and away from the opposing guide structure for selective change of the passage width.

7. A band saw blade stabilizer as claimed in claim 6 wherein the adjustor comprises an externally accessible hand operable set screw having a distal end disposed within a bore of said at least one guide structure.

8. A band saw blade stabilizer as claimed in claim 1 additionally comprising a thrust bearing situated behind and in contact with the saw blade for limiting rearward movement of the blade.

9. A band saw appliance comprising:
a) a work table;
b) a continuous band saw blade operably movable vertically through a slot in the work table; and
c) a band saw blade stabilizer for stabilizing the band saw blade during band saw blade operation, the stabilizer comprising:
i) two opposing guide structures situated to form a passage there between with a passage width such that the moving band saw blade can pass within said passage, whereby said guide structures limit lateral motion of the moving band saw blade within said passage; and
ii) an attachment mount for securing the guide structures to the band saw appliance above a work table of said appliance and through which the band saw blade travels.

10. A band saw appliance as claimed in claim 9 wherein the attachment mount of the blade stabilizer thereof is selectively vertically adjustable for increasing and decreasing distance of the guide structures from the work table.

11. A band saw appliance as claimed in claim 9 wherein the two guide structures of the blade stabilizer thereof are disposed within a single housing having a cut-out therethrough in alignment with the passage.

12. A band saw appliance as claimed in claim 9 wherein the guide structures of the blade stabilizer thereof are configured to present substantially flat opposing surfaces to each other.

13. A band saw appliance as claimed in claim 12 wherein the guide structures of the blade stabilizer thereof are configured as cubes.

14. A band saw appliance as claimed in claim 9 wherein at least one of said guide structures of the blade stabilizer thereof is provided with an adjustor for selective lateral movement of said at least one guide structure toward and away from the opposing guide structure for selective change of the passage width.

15. A band saw appliance as claimed in claim 14 wherein the adjustor of the blade stabilizer thereof comprises an externally accessible hand operable set screw having a distal end disposed within a bore of said at least one guide structure.

16. A band saw appliance as claimed in claim 9 wherein the blade stabilizer thereof additionally comprises a thrust bearing situated behind and in contact with the saw blade for limiting rearward movement of the blade.
